(19) United States
(12) Patent Application Publication
(10) Pub. No.: US 2009/0168125 A1
(43) Pub. Date: Jul. 2, 2009

(54) System and method of simplex and duplex scanning

(75) Inventors: Stephen Wilson, Lexington, KY (US); Charles Brandon Langrel, Lexington, KY (US); Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, inc

(21) Appl. No.: 12/006,191

(22) Filed: Dec. 31, 2007

(51) Int. Cl. H04N 1/04

(52) U.S. Cl. 358/496

(57) ABSTRACT

A scanning device for simplex and duplex scanning. The device may include a scan head for capturing content appearing on a page; a substantially C-shaped first scan path for simplex scanning, the first scan path adapted to guide the page relative to the scan head for scanning a first side of the page; a second scan path for duplex scanning, the second scan path adapted to guide the page relative to the scan head for scanning a first side of the page and a second side of the page; a path diverter, the path diverter adapted to direct the page to the first path or the second path; and a controller for controlling the first and second scan paths and the diverter. The second scan path forms a loop for moving the first and second sides of the page so that each is temporarily disposed adjacent the scan head.

### FIELD OF THE INVENTION

The present invention relates to a system and method of simplex and duplex scanning. Specifically, the present invention involves speeding up the scanning process by providing separate simplex and duplex scanning paths while retaining page collation.

### BACKGROUND OF THE INVENTION

The capability to scan a duplex document automatically is a useful feature in a multifunction printing device or other scanning device. Automatic document feeders (ADFs) help automatically scan documents or pages. Currently, the majority of automatic document feeders fall into two categories. In the first category, two scan heads, which are the imaging sensing units of the scanner, are used to capture both sides of a page at the same time as the paper passes through them. In the second category, a single scan head is used and the page to be scanned passes the scan head twice with one side facing the scan head during a first pass and the other side facing the scan head on a second pass.

The first category of ADFs has the ability to provide uncompromised scan speed compared to using only one scan head. However, incorporating two scan heads increases hardware costs and the physical size of the scanner. The second scan head may also require its own driving electronics and software support. Therefore, while dual scan head scanning system speeds are preferable, the costs associated with two scan heads may be prohibitive.

For the second category, there are two methods to make both sides of a page pass the scan head. One methods is to pull the page back and flip it after completion of the first pass. This allows the second side of the page to be scanned on the second pass. This is typically referred to as the re-circulating method. A second method involves looping the page to make it pass the scan head twice with the scan head seeing two different sides of the page. This is typically referred to as the looping method.

Implementing a single scan head provides cost and form factor advantages compared to dual scan heads. However, the decrease in costs and form factor result in a much slower scan speeds. The re-circulating method provides very slow scan speeds due to the required flipping of the page to complete the scanning process. The looping method is marginally faster, but the page still needs to pass through the scan head twice. Additionally, the looping method involves the page occupying the paper path after it passes the section of the paper path that loops back to the scan head. This results in a longer scan time because the next page cannot be loaded until the previous page is ejected. Therefore, the looping method hampers the potential to scan at a higher speed compared to simplex scanning.

It would be preferable to increase the scan speed of scanning systems while keeping costs and size to a minimum. Furthermore, it would be preferable to preserve the advantages of simplex scanning and looping duplex scanning while using only one scan head. Accordingly, the present invention is designed to overcome the shortcomings in current market products.

### SUMMARY OF THE INVENTION

Embodiments of the present invention solve one or more of the above problems by providing a scanning system and method that performs simplex and duplex scanning quickly and efficiently while allowing for the use of only one scan head.

An exemplary embodiment of the present invention provides a scanning device for simplex and duplex scanning comprising scanning hardware for reproducing contents of a page and output hardware for outputting the digital signals. The scanning hardware includes a scan head for converting the contents of the page to digital signals; a first path for simplex scanning, the first path adapted to guide the page to the scan head for scanning a first side of the page; a second path for duplex scanning, the second path adapted to guide the page to the scan head for scanning a first side of the page and a second side of the page; and a path diverter, the path diverter adapted to selectively direct the page to the first path or the second path. In one embodiment of the present invention, outputting the digital signals includes at least one of printing, faxing and emailing.

In accordance with an exemplary embodiment of the present invention, the second (duplex scan) path forms a loop for moving the page so that both sides thereof are temporarily positioned adjacent the scan head for generating image data. Further, the page is moved through the second path only in a forward direction, and the first path is substantially “C” shaped.

In another embodiment of the present invention, the scanning device may further include one or more sensing devices for detecting whether a page includes content on one or two sides of the page, the sensing device(s) outputting an electrical signal for use in activating the path diverter to guide the page to either of the first path or the second path. In this way, the decision to perform a simplex scan or duplex scan operation may be made without receipt of a user selecting the type of scan to be performed.

Another embodiment of the present invention may include an input interface allowing a user to choose to scan one or two sides of the page.

From the foregoing disclosure and the following detailed description of various preferred embodiments it will be apparent to those skilled in the art that the present invention provides a significant advance in the art of scanning systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 depicts an exemplary simplex path of an embodiment of the present invention.

FIG. 2 depicts an exemplary duplex path of an embodiment of the present invention.

FIG. 3 depicts a scan apparatus according to an embodiment of the present invention.

### DETAILED DESCRIPTION OF THE DRAWINGS

It will be apparent to those skilled in the art that many uses and variations are possible for the scanning system and method disclosed herein. The following detailed discussion of exemplary embodiments will illustrate the general principles of the invention. Other embodiments will be apparent to those skilled in the art given the benefit of this disclosure.

The disclosed scanning system, device and method may be incorporated within or into any scanning device or system. Exemplary systems may include, without limitation, standalone scanners, digital document senders, multifunction or all-in-one printing devices, or other scanning devices. Further, as used throughout this application, “simplex” and “simplex scanning” refer to scanning one side of a page or other object. “Duplex” and “duplex scanning” refer to scanning two sides of a page or other object. “Scan head” refers to any imaging device hardware capable of reproducing the contents of or a representation of a page or other object. Also, “scanner,” “scanning device,” “scanning system” and “ADF” are used interchangeably. “Page,” “paper” and “sheet” may also be used interchangeably.

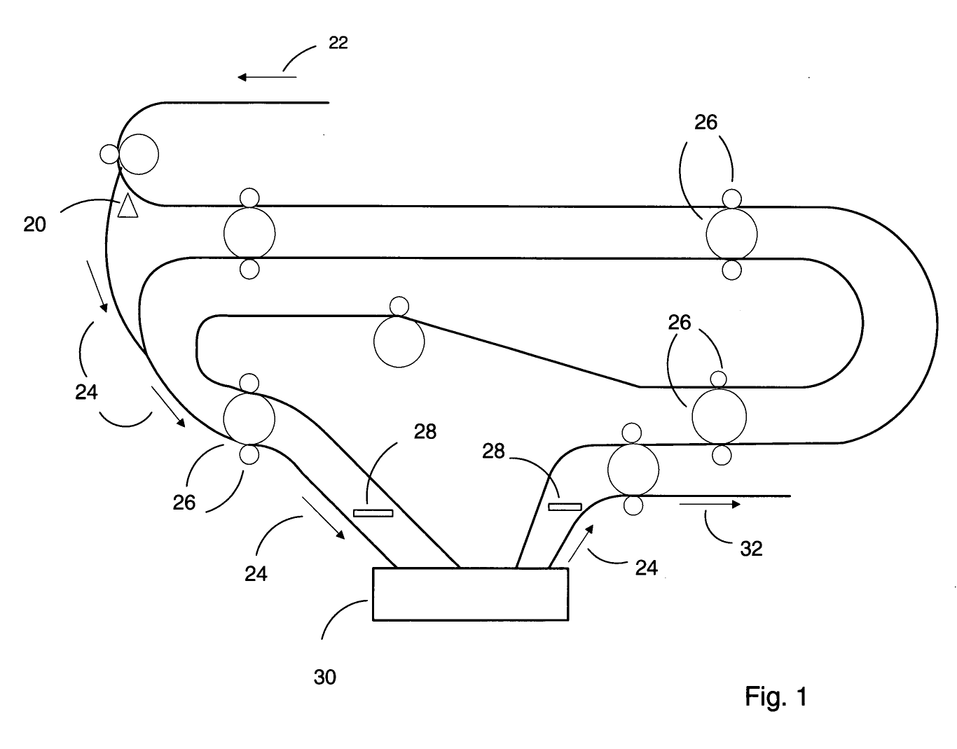

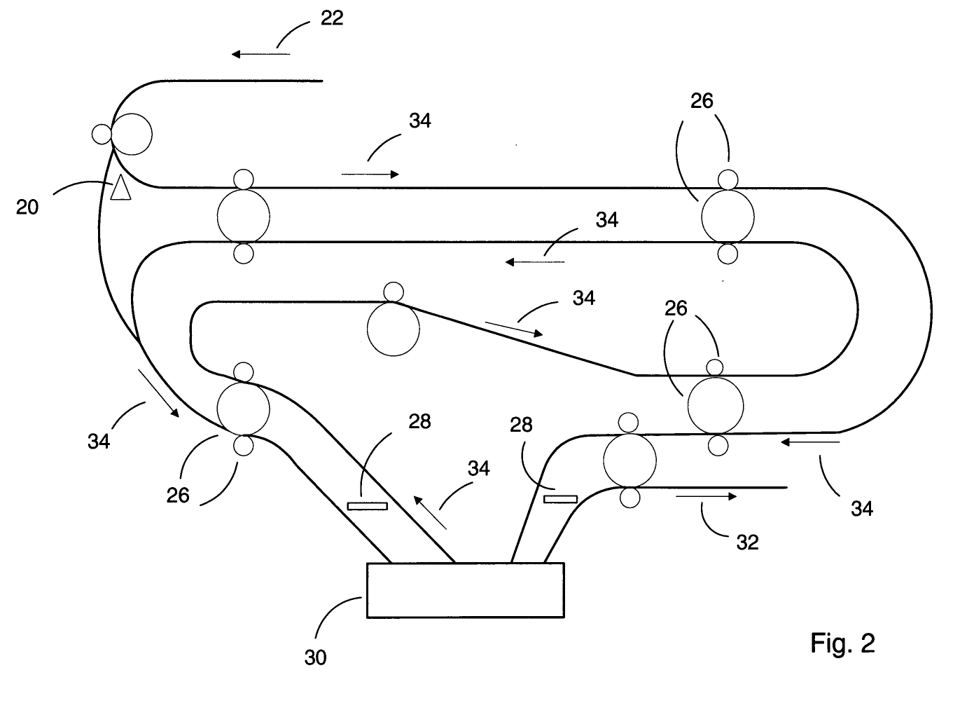

FIGS. 1 and 2 depict exemplary paths of various embodiments of the present invention. FIG. 1 depicts an exemplary simplex path of an embodiment of the present invention. FIG. 2 depicts an exemplary duplex path of an embodiment of the present invention. In these figures, a bold arrow shows the path that a page will follow in various embodiments.

As seen in FIGS. 1 and 2, one potential advantage of the exemplary embodiment of the present invention is that the ADF can accommodate both simplex and duplex modes of operation without degrading throughput speed for either. Switching between simplex and duplex paths is accomplished by the path diverter 20. When simplex scanning is needed, the path diverter 20 will utilize a “C” shaped path in one embodiment. The “C” path design is well known in the prior art and is generally known as one of the quickest and most efficient path designs for simplex scanning. When duplex scanning is needed, the path diverter 20 will utilize a looping duplex design. The looping duplex design provides speed and operational advantage over re-circulating duplex scan. In one embodiment of the present invention, the path diverter 20 is mechanically actuated. In other embodiments of the present invention, the path diverter 20 is actuated by at least one of a solenoid, a servomotor, an actuator, and a transducer (not shown). In addition, embodiments of the present invention may include one or more influence diverters 28 adapted to influence the page along one of the first path and the second path. In various embodiments of this first aspect, the one or more influence diverters may be actuated by at least one of gravity, the page, a solenoid, a servomotor, an actuator, and a transducer.

FIG. 1 depicts an exemplary simplex path of one embodiment of the present invention. Specifically, FIG. 1 depicts an exemplary embodiment showing a simplex scan page path 24. The page enters at an entry point 22 via manual feeding or by way of an automatic feed mechanism. For simplex scanning, the path diverter 20 directs the page to a first page path 24 for simplex scanning. This first page path 24 is depicted by representative arrows, and as can be seen in FIG. 1 is substantially C-shaped. Rollers 26 continuously or intermittently move or propel the page through the first page path 24. Diverters 28 may be located at various points along the first page path 24 to further guide and/or keep the page on the first page path 24, thus potentially avoiding paper jams, page skew and other possible errors in the scanning process. As the page travels along the first page path 24 and passes the scan head 30, one side of the page is scanned by the scan head 30. The page then exits the scanning device at an exit point 32.

FIG. 2 depicts an exemplary duplex path of an exemplary embodiment of the present invention. Specifically, FIG. 2 depicts the exemplary embodiment showing a duplex scan page path 34. The page enters at an entry point 22 via manual feeding or by way of an automatic feed mechanism. For duplex scanning, the path diverter 20 directs the page to a second page path 34 for duplex scanning. This second page path 34 is depicted by representative arrows. Rollers 26 continuously or intermittently move or propel the page through the second page path 34. Diverters 28 may be located at various points along the second page path 34 to further guide and/or keep the page on the second page path 34, thus potentially avoiding paper jams, page skew and other possible errors in the scanning process. As the page travels along the second page path 34 and passes the scan head 30, a first side of the page is scanned by the scan head 30. After this first pass, the page continues following the second page path 34. The second page path 34 loops the page such that a second side of the page is facing the scan head 30. As the page passes the scan head 30 for a second time, the second side of the page is scanned. The page then exits the scanning device at an exit point 32.

The looping duplex design has many advantages over the currently popular re-circulating duplex scan. The main advantage of a looping duplex scanner is improved throughput scanner speed. A looping duplex scanner can be implemented to feed the page in one continuous loop such that the page would never change direction. The looping duplex scan can be accomplished in two passes across the scan head 30 and then exit to an output bin. This is another advantage over the typical re-circulating duplex scanners. Typical re-circulating duplex scanners require three passes of the page to complete a scan. The additional third pass is to orient the page correctly to preserve collation. In the case of a looping duplex scan, the second paper path 34 is designed to orient the page correctly after the second side is scanned and exit to the output bin. This exemplary embodiment of the present invention retains the orientation and collation of multiple pages because the need to reverse or flip the page never arises.

Another potential advantage relates to the throughput scanner speed in that the common areas of the paper path may be reduced by the exemplary embodiments of the present invention. Typical re-circulating duplex scanners have to reuse the majority of the paper path when scanning the backside and orienting the page correctly before exiting to the output bin. This prevents the scanner from scanning additional sheets until the previous sheet is completed. The exemplary embodiments of the present invention are able to initiate the feeding of the next paper through second page path 34 while the first paper remains therein. Specifically, the exemplary embodiments of the present invention are able to stage the next sheet of paper closer to the scan head 30 while scanning of the first page is being completed. This may also increase the throughput scanner speed.

The exemplary embodiments of the present invention may reduce the design complexity and cost of current duplex scanners. Typical re-circulating duplex scanners require multiple motors and some method to reverse the motors and paper during feeding. This typically involves a clutch or solenoid. These additional hardware components add unnecessary costs and complexity. The exemplary embodiments of the present invention are able to use fewer motors to drive the paper in the same direction and maintain collation such that the paper would not need to be reversed during scanning. Furthermore, the clutches or solenoids that are typically used in current duplex scanners increase the audible noise level of the scanning device. The exemplary embodiments of the present invention would not require these additional hardware components, thus allowing for a substantial reduction in audible noise levels.

Compared to a re-circulating duplex scanner, the reliability of a looping duplex scanner is improved. In the exemplary embodiments, the paper is fed in only one direction, which means that the leading edge of the paper never changes. This can improve the feed reliability of the device. Reversing the direction of the paper can lead to paper jams, skew, and/or paper damage. A looping duplex scanner has a relatively longer paper path, but the page is only fed in one direction, thus maintaining the same leading edge. In one embodiment, the only area of the paper path that would need to be common in a looping duplex scanner is the scan head 30. The rollers 26 and diverters 28 may be designed such that reversing the rollers 26 is not required.

Furthermore, some users may be confused when seeing part of the paper while it is scanning. This is typical for current re-circulating duplex scanners. Various embodiments of present invention would not have any part of the paper visible to the user during scanning. This will help prevent user confusion.

A feature of the above exemplary embodiments of the present invention includes incorporating a simplex and duplex scanning into the same scanning device while not compromising the scan speed. In order not to compromise the simplex scan time, the exemplary embodiments of the present invention are designed to include a shorter paper path for simplex scanning. Many users only require simplex scanning. The exemplary embodiments of the present invention do not compromise simplex scanning speed by requiring that both simplex and duplex scan jobs follow the same paper path.

There can be potentially numerous paper paths to implement embodiments of the present invention. FIGS. 1 and 2 show examples which allow the ADF unit to be packaged at the right end of the scanner. This will provide both functional and construction advantages. Embodiments of the present invention can also be implemented more compactly by folding the looping portions of the paper feeding. This would make the scanning device more compact in size and require less hardware materials.

In one embodiment of the present invention, one or more sensing devices or sensors 42 may be implemented in the paper path. In an exemplary embodiment, this sensor(s) 42 would be placed at the beginning of the paper path. The sensor(s) 42 would perform sensing prior to the page reaching the path diverter 20. Such sensor(s) 42 has the ability to determine whether a page has content on only one side or on two sides. This sensor(s) 42 would potentially eliminate the need for user input regarding whether to perform simplex or duplex scanning. Ideally, this sensor(s) 42 would be an optical sensor, but any sensing device(s) capable of determining whether a page has content on only one side or on two sides would suffice.

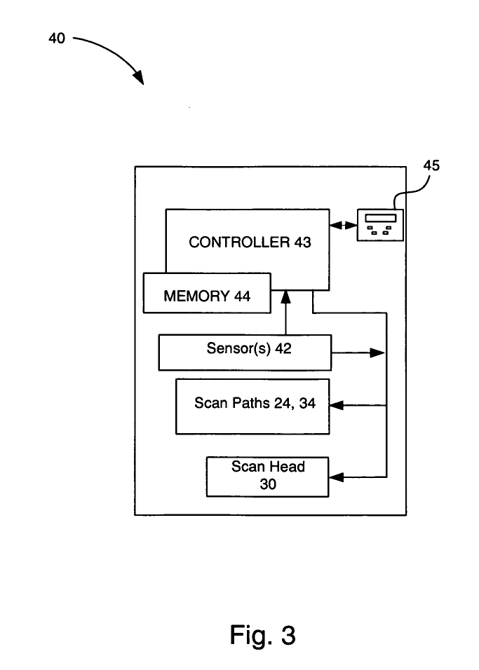

FIG. 3 is a block diagram representing a scanning apparatus 40 according to an exemplary embodiment of the present invention. Apparatus 40 may, for example, be a multifunction printer having the capability to print and scan documents. It is understood, however, that apparatus 40 may be any device capable of scanning a sheet of media. Apparatus 40 may include first (simplex scan) page path 24 and second (duplex scan) page path 34 as described above and in FIGS. 1 and 2, and scan head 30 which captures image data corresponding to the content appearing on at least one side of a sheet of media, as described above. Scan head 30 may include a substantially transparent scan head buffer manufactured from one of glass, a plastic, a polymer and a composite.

Apparatus 40 may also include a sensor(s) 42 which detects whether a sheet of media received by apparatus 40 includes content on only one or both sides of the sheet, as described above.

Apparatus 40 may include a controller 43 which controls scan paths 24, 34 and scan head 30 for performing simplex and duplex scan operations on one or more sheets of media. Controller 43 may include a processor and/or other logic for controlling scanning operations, and may execute scan program instructions stored in memory 44. Apparatus 40 may further include a user interface 45 which receives user commands and sends such commands to controller 43 for execution. User interface 45 may be adapted to allow a user of apparatus 40 to, among other things, choose the first page path 24 for simplex scanning or the second page path 34 for duplex scanning. In some embodiments of the present invention, user interface 45 may include at least one of a button, an actuator, a switch, a lever, a touch screen, and a graphical user interface. When a user command to perform a scan operation is received by user interface 45, such command is sent to controller 43 which controls scan paths 24, 34 and scan head 30 based upon the user command.

In another embodiment of the present invention, user interface 45 is a graphical user interface, the graphical user interface displaying options associated with choosing the first path 24 for simplex scanning and choosing the second path 34 for duplex scanning. In this embodiment, upon a user actuating the option to choose the first path 24 for simplex scanning causes the path diverter 20 to divert the page to the first path 24 and upon a user actuating the option to choose the second path 34 for duplex scanning causes the path diverter 20 to divert the page to the second path 34. In addition, user interface 45 may be adapted to allow a user to choose how the digital signals will be outputted or otherwise utilized.

It is understood that apparatus 40 may include additional components to perform simplex and duplex scan operations, such as motors, servers and the like for moving scan head 30 over an area in which a sheet of media is positioned, in order to capture image data corresponding to content appearing on the sheet, as known in the art. Alternatively, scan head 30 captures image data in other ways. Such components will not be described in detail for reasons of simplicity.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A scanning device for simplex and duplex scanning, comprising:
a scan head for converting the contents of a first page into digital signals;
a first path for simplex scanning, the first path having a substantially “C” shape adapted to guide the first page to the scan head for scanning a first side of the first page;
a second path for duplex scanning, the second path adapted to guide the first page to the scan head for scanning a first side of the first page and a second side of the first page; and
a path diverter adapted to direct the first page to the first path or the second path, wherein the scanning devices moves the first page in the second path in only a forward direction.

2. The scanning device of claim 1, further comprising:
a user interface adapted to allow a user to choose the first path for simplex scanning or the second path for duplex scanning, the user interface controlling the path diverter based upon selections received from a user.

3. The scanning device of claim 1, further comprising:
at least one sensor for detecting whether the first page contains content on both sides thereof, the at least one sensor providing a sensor output signal.

4. The scanning device of claim 3, further comprising:
a controller for determining whether simplex or duplex scanning is to be performed on the first page, based upon the sensor output signal, and controlling the path diverter accordingly.

5. The scanning device of claim 1, further comprising a controller which determines whether simplex or duplex scanning is to be performed on the first page in the absence of user input selecting between simplex and duplex scanning.

6. The scanning device of claim 1, wherein the scanning device comprises a multifunction printing apparatus.

7. The scanning device of claim 1, wherein the second path forms a loop for moving each of a first side and a second side of the first page so as to be adjacent the scan head.

8. The scanning device of claim 1, further comprising a controller for controlling operation of the scanning device, the controller moving a second page in the second path while the first page is in the second path.

9. A method for scanning printed media, comprising:
receiving a first page to be scanned;
selectively moving the first page through a simplex scan path in a substantially C shape, in the event a simplex scan operation is to be performed on the first page;
selectively moving the first page through a duplex scan path so that a first side and a second side of the first page is positioned adjacent a scan head, the first page moving through the duplex scan path only in a forward direction; and
generating signals, by the scan head, corresponding to content appearing on the first and second sides of the first page.

10. The method of claim 9, further comprising:
determining that the first page is to be scanned using a duplex scan operation, the determination being made in an absence of user selection information.

11. The method of claim 9, further comprising:
sensing whether the first page includes content appearing on both the first side and the second side of the first page, the determining being based upon the sensing.

12. The method of claim 9, wherein moving the first page comprises moving the first page in a loop.

13. The method of claim 9, further comprising:
moving a second page through the duplex scan path while the first page is being moved therein.

14. A scanning apparatus, comprising:
a scan head;
a substantially C-shaped simplex scan path for moving a first media sheet relative to the scan head so that a first side of the first media sheet is temporarily positioned adjacent the scan head;
a duplex scan path for moving the first media sheet relative to the scan head so that the first side and a second side of the first media sheet are each temporarily positioned adjacent the scan head, the duplex scan path forming a loop; and
a controller for controlling the simplex and duplex scan paths.

15. The apparatus of claim 14, wherein the controller controls the duplex scan path so that the first media sheet is moved through the duplex scan path in only a forward direction.

16. The apparatus of claim 14, wherein the controller determines whether a simplex scan operation or a duplex scan operation is to be performed on the first media sheet, the determination being made without a user of the scanning apparatus selecting between the simplex scan operation and the duplex scan operation.

17. The apparatus of claim 14, further comprising at least one sensor for detecting whether the first side and the second side of the first media sheet each contain content, wherein the controller determines whether a simplex scan operation or a duplex scan operation is to be performed on the first media sheet based upon the detection by the sensor.

18. The apparatus of claim 14, wherein the controller controls the duplex scan path so that a second media sheet is moved into the duplex scan path while the first media sheet is therein.
